(19) United States
(12) Patent Application Publication
(10) Pub. No.: US 2006/0244390 A1
(43) Pub. Date: Nov. 2, 2006

(54) Light emitting display, and apparatus and method for digitizing brightness thereof

(76) Inventor: Sun A. Yang, Suwon (KR)

Correspondence Address: CHRISTIE, PARKER & HALE, LLP, PO BOX 7068, PASADENA, CA, 91109-7068, US

(21) Appl. No.: 11/403,249

(22) Filed: Apr. 12, 2006

(30) Foreign Application Priority Data
Apr. 28, 2005 (KR) 2005-35777

(51) Int. Cl. G09G 3/10

(52) U.S. Cl. 315/169.3

(57) ABSTRACT

An apparatus for digitizing a brightness of a light emitting display includes a brightness measuring part for generating a brightness data for a number of photographic areas of the light emitting display. The apparatus also includes a calculating part for calculating: a mean value of the generated brightness data; a standard deviation of the generated brightness data; a standard deviation/mean value, for the number of photographic areas. The apparatus also includes a storing part for storing the mean value, the standard deviation and the standard deviation/mean value calculated by the calculating part. The apparatus may also include a determining part for comparing the standard deviation/mean value with a reference value, and correspondingly determining whether the performance of the light emitting display is favorable or unfavorable.

### CROSS-REFERENCE TO RELATED APPLICATIONS

This application claims the benefit of Korean Patent Application No. 2005-35777, filed on Apr. 28, 2005, in the Korean Intellectual Property Office, the disclosure of which is incorporated herein in its entirety by reference.

### BACKGROUND

1. Field of the Invention

The present invention relates to a light emitting display, an apparatus and a method for digitizing the brightness of the display, and more particularly to a light emitting display, an apparatus and a method for digitizing the brightness of the display and method for measuring a brightness thereof by evaluating the mean and standard deviation of the brightness.

2. Discussion of Related Art

Thin and lightweight flat display apparatuses have been used as portable information terminals. Examples include a personal computer, a mobile station, a PDA, and monitors for all kinds of information equipment. As the flat displays, an LCD using a liquid crystal panel, an organic light emitting display using an OLED (Organic Light Emitting Diode), a PDP using a plasma panel, etc. are well known. Among the flat displays, the organic light emitting display has recently attracted attention.

FIG. 1 is a construction view of a structure of a conventional light emitting display. Referring to FIG. 1, the conventional light emitting display includes a number of pixels 11 surrounded by a number of scan lines Sn−1, Sn, Sn+1, a number of data lines Dm−1, Dm, Dm+1, and a number of power lines VDDm−1, VDDm, VDDm+1.

Each pixel 11 includes an organic light emitting diode (OLED) and a pixel circuit 30 for causing the OLED to emit light. The plurality of scan lines Sn−1, Sn, Sn+1 are formed in rows, and the data lines Dm−1, Dm, Dm+1 and the power lines VDDm−1, VDDm, VDDm+1 are formed in columns. Thus, the pixel 11 receives a data signal from the data line Dm−1 when a scan signal is applied to the scan line Sn−1, Sn, Sn+1, and the corresponding pixel emits light. The anode of the OLED is connected with the pixel circuit 30, and the cathode is connected with the second power line VSS. This OLED includes an EML(Emitting Layer), an ETL(Electron Transport Layer), and an HTL(Hole Transport Layer) formed between the anode and cathode. Further, the OLED includes an EIL(Electron Injection Layer) and an HIL(Hole Injection Layer). When a voltage is applied between the anode and cathode of the OLED, electrons generated from the cathode move into the EML via the EIL and ELT, and electrons generated from the anode move into the EML via the HIL and the HTL. Therefore, the electrons generated from ETL and holes generated from the HTL are recombined causing light to be emitted from the EML.

The pixel circuit 30 includes a first transistor T1 connected between the first power line VDDm−1 and the OLED, a second transistor T2 connected between the first transistor T1, the data line Dm−1 and the scan line Sn−1, Sn, Sn+1, and a capacitor Cst connected across the gate and source of the first transistor T1. The gate of the first transistor T1 is connected with a first electrode of the capacitor Cst, and the source of the first transistor T1 is connected with a second electrode of the capacitor Cst and the first power line VDDm−1. The drain of the first transistor T1 is connected with the anode of the OLED. The first transistor T1 controls a current flowing from the first power line VDDm−1 to the OLED corresponding to the data signal provided through the second transistor T2 thereto. At this time, the first transistor T1 of each pixel 11 is formed in the same row and column.

The gate of the second transistor T2 is connected with the scan line Sn−1, and the source is connected with the data line Dm. The drain of the second transistor T2 is connected with the first electrode of the capacitor Cst. The second transistor T2 is turned on when the scan signal is provided from the scan line Sn−1 thereto such that the second transistor T2 provides the capacitor Cst with the data signal from the data line Dm. At this time, the capacitor Cst is charged with a voltage corresponding to the data signal.

In each pixel of the light emitting display, when the scan signal is provided to the scan line Sn−1, the second transistor T2 is turned on such that the second transistor T2 provides the gate of the first transistor T1 with the data signal provided to the data line Dm. At this time, the capacitor Cst is charged with the difference between a driving voltage provided through the first power line VDD and the data signal provided to the gate of the first transistor T1. The first transistor T1 controls the current provided from the first power line VDD to the OLED in response to the data signal provided to the gate such that the quantity of light of the OLED is controlled. And, when the second transistor T2 is turned off, the first transistor T1 maintains the light emission of the OLED by providing a constant current to the OLED until a data signal of a next frame is provided thereto.

Thus, in each pixel 11 of the light emitting display, the first transistor T1 of the pixel circuit 30 controls the current provided to the OLED according to the voltage provided to the gate thereof. Accordingly, the first transistor T1 plays the role of controlling the quantity of emitting light of the OLED. Namely, the current Ids provided to the OLED through the first transistor T1 is determined by Equation 1 as

$$Ids = \frac{1}{2} \times \frac{W}{L} \times μ {Cox ( Vgs - Vth )}^{2} \qquad ( 1 )$$

where W and L are the channel width and length of the first transistor T1, respectively, Vgs is the voltage that is applied across the gate and source of the first transistor T1, Vth is the threshold voltage of the first transistor T1, μ is the mobility, and Cox is the gate capacity by the unit area of the first transistor T1. Referring to Equation 1, we know that the current Ids provided through the first transistor T1 is influenced by the threshold voltage Vth, the mobility p and the data voltage provided to the gate of the first transistor T1.

In a manufacture process for the light emitting display, the process of forming a semiconductor layer of the first and second transistors, T1 and T2, respectively, of each pixel 11 includes a crystallizing process. An amorphous-silicon thin film patterned on a substrate becomes a poly-silicon thin film by crystallizing. At this time, the process of crystallizing the amorphous-silicon thin film into the poly-silicon thin film has the disadvantage that the characteristics, such as the crystal size of the poly-silicon thin film, mobility, etc., are varied.

When the poly-silicon thin film is used as a semiconductor layer of the first transistor T1, the first transistor T1 has irregular characteristics in the threshold voltage and mobility such that a problematic brightness deviation is generated between the pixels that receive the same signal.

Hereinafter, exemplary embodiments according to the present invention will be described with reference to the accompanying drawings. Here, when one element is connected to another element, the element may be not only directly connected to the other element but also indirectly connected to the other element via another element. Further, irrelative elements are omitted for clarity. Finally, like reference numerals refer to like elements throughout.

### SUMMARY

Exemplary embodiments of the present invention provide a light emitting display, an apparatus and a method for measuring the brightness thereof by digitizing brightness generated from the light emitting display.

According to one embodiment of the present invention, an apparatus for digitizing a brightness of a light emitting display is provided. The apparatus includes a brightness measuring part for generating brightness data for a number of photographic areas of the light emitting display. The apparatus also includes a calculating part for calculating: a mean value of the generated brightness data; a standard deviation of the generated brightness data; a standard deviation/mean value, for the plurality of photographic areas. The apparatus also includes a storing part for storing the mean value, the standard deviation and the standard deviation/mean value calculated by the calculating part. The apparatus may further include a determining part for comparing the standard deviation/mean value with a reference value and determining that the light emitting display is favorable when the standard deviation/mean value is less than the reference value.

According to one embodiment of the present invention, a light emitting display includes: an image display area including a number of pixels and a dummy area. The light emitting display includes at least one visually recognizable landmark in the dummy area.

According to one embodiment of the present invention, a method of digitizing a brightness of a light emitting display includes generating brightness data by recognizing the brightness for a number of predetermined areas of the light emitting display. The method also includes calculating: a mean value of the generated brightness data, a standard deviation of the generated brightness data and a standard deviation/mean value.

These and other features and advantages of the embodiments will become apparent to those skilled in the art from the following detailed description and accompanying figures. It should be understood, however, that the detailed description and specific examples, including figures, while indicating various embodiments, are given by way of illustration and not limitation. Many modifications and changes within the scope of the embodiments may be made without departing from the spirit thereof and the invention includes all such modifications.

### BRIEF DESCRIPTION OF THE DRAWINGS

FIG. 1 is a circuit diagram showing a structure of a conventional light emitting display;

FIG. 2 is a block diagram showing a structure of a brightness digitizing apparatus of a light emitting display according to the present invention;

FIG. 3 is a view showing one embodiment of the light emitting display of which its brightness is measured by a brightness measuring apparatus according to the present invention;

FIG. 4 is a view showing standard deviation/brightness mean values measured by a digitizing apparatus according to the present invention; and

FIG. 5 is a circuit diagram showing one embodiment of a pixel which is included in a light emitting display according to the present invention.

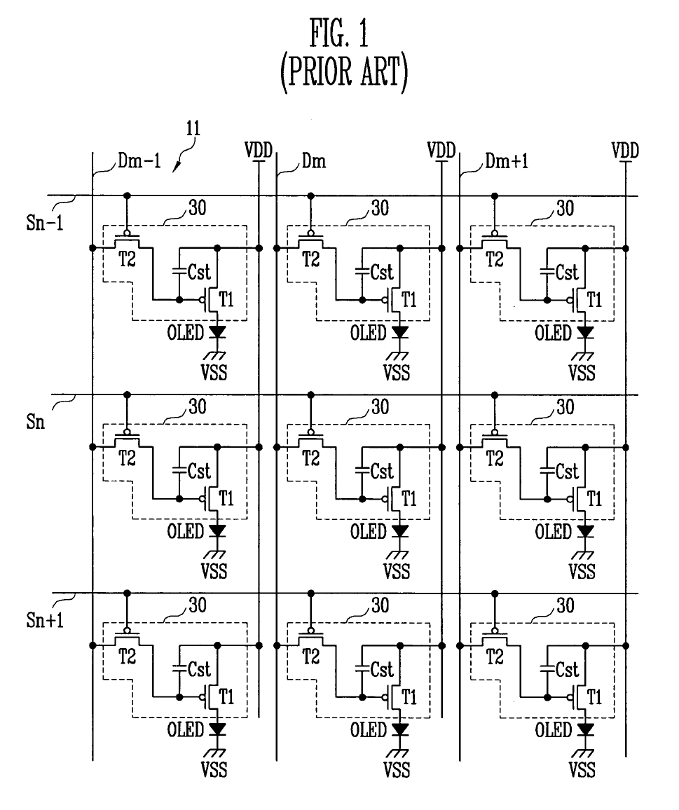

### DETAILED DESCRIPTION

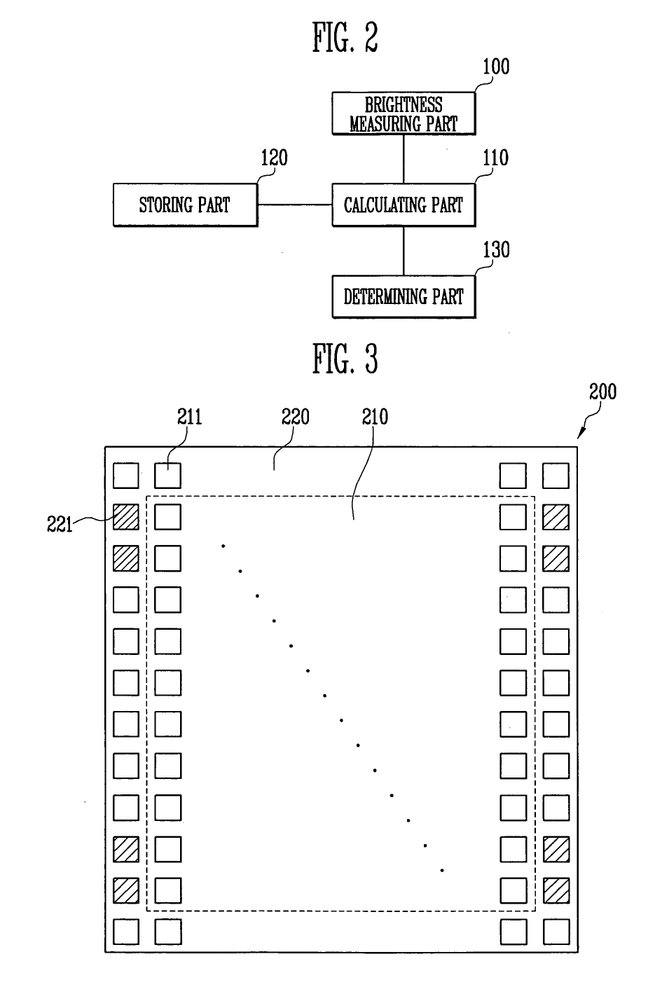

FIG. 2 is a block diagram view showing a structure of a brightness digitizing apparatus of a light emitting display according to the present invention. Referring to FIG. 2, the brightness digitizing apparatus may include a brightness measuring part 100, a calculating part 110, a storing part 120, and a determining part 130.

The brightness measuring part 100 may generate brightness data derived from the brightness of the light emitting display. Generating brightness data may be performed by taking photographs of the predetermined photographic areas in the light emitting display using a CCD camera, etc. The brightness measuring part 100 may generate red brightness data, green brightness data, and blue brightness data by taking photographs of the predetermined photographic areas at such states as when the light emitting display displays only a red color, only a green color, and only a blue color, respectively. Alternately, since the green color is the most sensitive color to the human eye, the brightness of only the green color may be used. The method for obtaining the brightness data using the CCD camera, etc. is well known to those skilled in the art.

The brightness measuring part 100 may move along the X and Y coordinate axes and correspondingly over the light emitting display.

The calculating part 110 may calculate a mean value and a standard deviation of the brightness of the entire light emitting display using the brightness data from the photographic areas that was generated by the brightness measuring part 100.

The mean value of brightness is obtained from the plurality of red data, the plurality of green data, and the plurality of blue data, respectively. The standard deviation is a deviation between the sampled values and the mean value obtained by Equation 2:

$$\sqrt{{\sum }_{k = 1}^{n} {( {X}_{k} - {X}_{m} )}^{2} / n} \qquad ( 2 )$$

where each value of Xₖ is a sampled value for a color red, blue or green, n is the number of sampled values and Xₘ is the mean value for a color red, blue or green.

Over a light emitting display, a high standard deviation means that the brightness of the light emitting display is not uniform and, correspondingly, the brightness deviation is high. However, since this standard deviation varies according to brightness, one may use a numerical value that does not vary with brightness. This numerical value may be the result of dividing the standard deviation by the mean value. Accordingly, the brightness component is removed. Consequently, the standard deviation/mean value may be independent of the brightness.

The storing part 120 may store an algorithm by which the calculating part 110 calculates the mean value of brightness, the standard deviation value and the standard deviation/mean value using the brightness data, and the values calculated by the algorithm. The algorithm may include: a first set of instructions adapted to cause the calculating part 110 to calculate a mean value of brightness; a second set of instructions adapted to cause the calculating part 110 to calculate a standard deviation; and a third set of instructions adapted to cause the calculating part 110 to calculate a standard deviation/mean value for the photographic areas.

The determining part 130 may determine that the light emitting display is favorable when the standard deviation/mean value is less than a reference value or that the light emitting display is not favorable when the standard deviation/mean value is more than the reference value. The party performing the measuring may also be informed of the result.

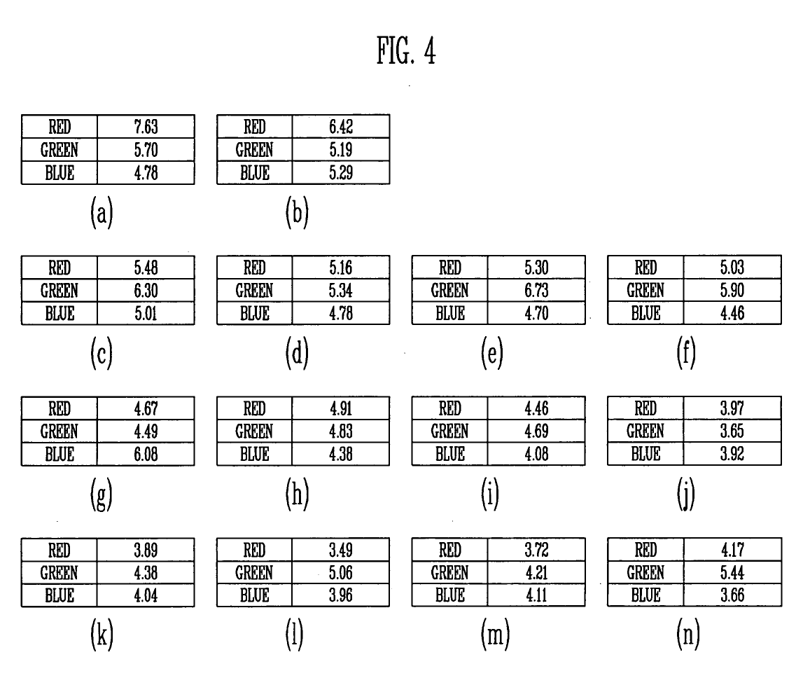

FIG. 3 is a view showing one embodiment of the light emitting display of which its brightness is measured by a brightness measuring apparatus according to the present invention. Referring to FIG. 3, the pixel part 200 may include a number of pixels 211. The pixel part 200 may be divided into an image display area 210 on which an image may be displayed and a dummy area 220 on which an image is not displayed. Though the image display area 210 and the dummy area 220 may each include pixels 211, the dummy area 220 may be formed along a rim of the image display area 210 and may be positioned under a portion of a case, etc. via a final manufacture process such that a user cannot see the dummy area 220.

In one embodiment, the dummy area 220 includes a landmark 221. By forming a landmark 221, recognized as a starting point located at a portion of the dummy area 220, a photographic area of image display area 210 may be determined with reference to the landmark 221. Because the landmark 221 is located under the case, etc. and therefore may not be seen while the display is being used, and the image display area 210 may be exposed when measuring the brightness, the photographic area of image display area 210 is determined with reference to the landmark 221 formed at the dummy area 220.

The photographic area may be a portion of the light emitting display that is separated from the landmark 221 by a predetermined distance. Further, the photographic area means an area to be photographed that is on the image display area 210. The photographic areas may be determined either by selecting more than one predetermined distance from a single landmark 221, or by selecting areas that are at a predetermined distance from each of a number of landmarks 221, where each landmark 221 is formed at the dummy area 220. By forming a number of landmarks 221 in the dummy area 220 and selecting a number of predetermined distances from each of the landmarks 221, it is possible for the brightness measuring part 100 to take photographs of the photographic areas.

The landmark 221 may be visually recognized. A white light may be used as the landmark 221 by forming a light emitting device emitting a white light without also forming a corresponding light emitting device emitting red, green and blue light at a pixel formed at the dummy area 220.

In one embodiment, the landmark 221 is not present. In the case when there is no landmark 221 in the light emitting display, X and Y coordinate axes with reference to a particular reference portion 214, such as an edge of the light emitting display, etc., may be set and areas at a predetermined distance away from the reference portion may be photographed.

FIG. 5 is a circuit diagram showing one embodiment of a pixel which is included in a light emitting display according to the present invention. Referring to FIG. 5, the pixel 211 may include an organic light emitting diode (OLED) and a pixel circuit 212. The pixel circuit 211 may also include the first through fifth transistors M1 through M5, and the first and second capacitors Cst and Cvth.

The source of the first transistor M1 may be connected with the first power source VDD, and the drain of the first transistor M1 may be connected with a first node A. The gate may be connected with the second node C, such that a current may flow from the source to the drain when voltage is applied to the second node C.

The source of the second transistor M2 may be connected with a data line Dm, the drain may be connected with the third node B, and the gate may be connected with the first scan line Sn, such that the data signal Dm may be selectively provided to the third node B by the first scan signal that is provided through the first scan line Sn.

The source of the third transistor M3 is connected with the first node A, the drain is connected with the second node C, and the gate is connected with the second scan line Sn−1, such that the third transistor M3 selectively becomes a diode-circuit by the second scan signal that is provided through the second scan line Sn−1 to the third transistor M3.

The source of the fourth transistor M4 is connected with the first power source VDD, the drain is connected with the third node B, and the gate is connected with the second scan line Sn−1, such that the first power source VDD is selectively provided to the third node B by the second scan signal that is provided through the second scan line Sn−1 thereto.

The source of the fifth transistor M5 is connected with the first node A, the drain is connected with the anode of the OLED, and the gate is connected with a light emitting control line En, such that a current that flows from the source of the fifth transistor M5 toward the drain is selectively provided to the OLED.

The first electrode of the first capacitor Cst is connected with the first power source VDD, and the second electrode is connected with the third node B, such that a predetermined voltage is charged on the capacitor Cst by the voltage of the data signal and the first power source VDD when the data signal is provided to the third node B.

The first electrode of the second capacitor Cvth is connected with the third node B, and the second electrode is connected with the second node C, such that the second capacitor Cvth is charged with the threshold voltage when the first transistor M1 becomes a diode circuit in above-noted manner.

The anode of the OLED is connected with the drain of the fifth transistor M5, the cathode is connected with the second power source Vss such that the OLED emits light by a current that flows from the first node A thereto through the fifth transistor M5.

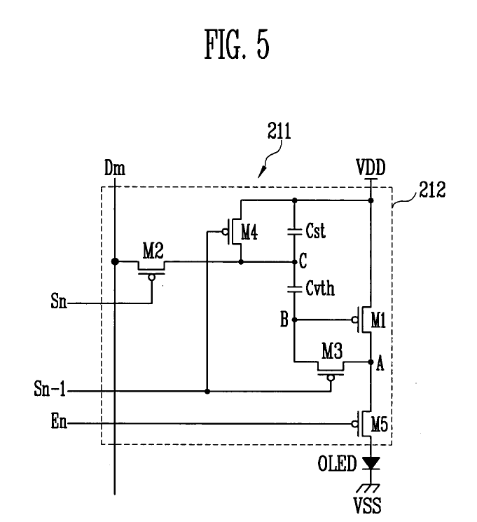

FIG. 4 is a view showing standard deviation/brightness mean values measured by a digitizing apparatus according to the present invention. Referring to FIG. 4, an apparatus for digitizing a brightness of red, green and blue was used and standard deviation/brightness mean value was calculated for each color over the entire light emitting display. The standard deviation/brightness mean values were each expressed as a percentage. The results are presented for light emitting displays a through n, with a total of 14 light emitting displays measured. The standard deviation/brightness mean value of each light emitting display was expressed as percentage.

Further, the light emitting displays a through n were observed visually to determine whether there was a brightness deviation or not. The light emitting displays a through f showed a brightness deviation, and were determined to be unfavorable. The light emitting displays g through n did not show a brightness deviation and were therefore determined to be favorable.

Examining the light emitting displays a through f, each standard deviation/brightness mean value for red, green and blue is more than approximately 4.5%. And each of the standard deviation/brightness mean values of the light emitting displays g through n for red, green and blue is equal to or less than approximately 4.5%.

Therefore, when approximately 4.5% is taken as a reference value of the standard deviation/brightness mean value for red, green and blue colors, it can be determined that the light emitting display is unfavorable when the value is more than approximately 4.5% and favorable when the value is equal to or less than approximately 4.5%.

The brightness deviation may be determined using different references by different testers, and the test time can be reduced as well.

Although a few embodiments of the present invention have been shown and described, it is appreciated by those skilled in the art that changes can be made in those embodiments without departing from the principles and spirit of the invention, the scope of which is defined in the claims and their equivalents.

What is claimed is:

1. An apparatus for digitizing a brightness of a light emitting display comprising:
a brightness measuring part for generating a brightness data for a plurality of photographic areas of the light emitting display;
a calculating part for calculating:
a mean value of the generated brightness data;
a standard deviation of the generated brightness data;
a standard deviation/mean value, for the plurality of photographic areas; and
a storing part for storing the mean value, the standard deviation and the standard deviation/mean value calculated by the calculating part.

2. The apparatus as claimed in claim 1, further comprising a determining part for comparing the standard deviation/mean value with a reference value and determining that the light emitting display is favorable when the standard deviation/mean value is less than the reference value.

3. The apparatus as claimed in claim 2, wherein the reference value is approximately 4.5%.

4. The apparatus as claimed in claim 1, wherein the light emitting display is divided into an image display area and a dummy area, and the light emitting display includes at least one landmark in the dummy area.

5. The apparatus as claimed in claim 4, wherein the landmark includes a light emitting diode for emitting a color of monochromatic wavelength.

6. The apparatus as claimed in claim 4, further comprising a predetermined area formed with reference to a location of the landmark.

7. The apparatus as claimed in claim 1, wherein the brightness measuring part sets coordinates on the light emitting display and determines a predetermined area according to the coordinates.

8. The apparatus as claimed in claim 1, wherein the brightness data comprises:
red brightness data;
green brightness data; and
blue brightness data.

9. The apparatus as claimed in claim 4, further comprising a reference portion of the light emitting display. wherein at least one of the plurality of photographic areas is located in the image display area at a predetermined distance from the reference portion.

10. The apparatus as claimed in claim 1, wherein the storing part further comprises instructions including:
a first set of instructions adapted to cause the calculating part to calculate a mean value of generated brightness data for the photographic areas;
a second set of instructions adapted to cause the calculating part to calculate a standard deviation of generated brightness data for the photographic areas; and
a third set of instructions adapted to cause the calculating part to calculate a standard deviation/mean value for the photographic areas.

11. The apparatus as claimed in 2, wherein the determining part further determines that the light emitting display is unfavorable when the standard deviation/mean value is more than the reference value.

12. The apparatus of claim 1, wherein the brightness measuring part generates brightness data by taking photographs of the plurality of the photographic areas.

13. A light emitting display comprising:
an image display area comprising a plurality of pixels;
a dummy area; and
at least one visually recognizable landmark in the dummy area.

14. The light emitting display as claimed in claim 9, wherein the dummy area comprises a landmark that comprises a light emitting diode configured to emit a color of monochromatic wavelength.

15. The light emitting display as claimed in claim 13, wherein the dummy area comprises at least one visually recognizable landmark.

16. A method of digitizing a brightness of a light emitting display comprising:
generating brightness data by recognizing a brightness for a plurality of predetermined areas of the light emitting display; and
calculating:
a mean value of the generated brightness data;
a standard deviation of the generated brightness data; and
a standard deviation/mean value.

17. The method as claimed in claim 16, further comprising:
determining that the light emitting display performs unfavorably when the standard deviation/mean value is more than approximately 4.5%.

18. The method as claimed in claim 16, wherein the brightness data comprises:
red brightness data;
green brightness data; and
blue brightness data.

19. The method as claimed in claim 16, wherein at least one landmark is included in the light emitting display, and one of the plurality of predetermined areas is determined with reference to the landmark.
